(19) United States
(12) Patent Application Publication
(10) Pub. No.: US 2003/0210783 A1
(43) Pub. Date: Nov. 13, 2003

(54) Method and system of encryption

(76) Inventor: Ross Filippi, Milton Keynes (GB)

Correspondence Address: NIXON & VANDERHYE, PC, 1100 N GLEBE ROAD, 8TH FLOOR, ARLINGTON, VA, 22201-4714, US

(21) Appl. No.: 10/366,694

(22) Filed: Feb. 14, 2003

Related U.S. Application Data
(63) Continuation-in-part of application No. 10/351,359, filed on Jan. 27, 2003.
Application No. 10/351,359 is a continuation-in-part of application No. PCT/EP01/08744, filed on Jul. 27, 2001.

(30) Foreign Application Priority Data
Jul. 27, 2000 (AU) PQ9041

(51) Int. Cl. H04L 9/00

(52) U.S. Cl. 380/44

(57) ABSTRACT

A method of data encryption comprising the steps of obtaining a plurality of sub-keys from a secure long key, and generating an encryption key from the sub-keys by (i) assigning a significance to each sub-key from most significant to least significant; (ii) using bit values obtained from a given position of each sub-key to determine a bit of the encryption key; (iii) rotating the bit values of the least significant sub-key; (iv) repeating steps (ii) and (iii) a predetermined number of times and then rotating a next most significant sub-key, and v) repeating steps (ii), (iii) and (iv) for one or more of the sub-keys in order of increasing significance. There is also disclosed a system for providing a pseudo random data stream used to encrypt an information stream.

### TECHNICAL FIELD

The present invention relates to the provision of secure communications and/or storage by way of encryption of an information stream, where an information stream is any source of data such as a message, file or data contained within an information storage device.

### BACKGROUND OF THE INVENTION

Encryption is an extremely large field which is of increasing importance, due to the increase in traffic over telecommunications systems and particularly the Internet, and the desire for providing secure communication of information over such systems Where encryption is required in bi-directional communications between two parties, a symmetric encryption algorithm is typically used. A symmetric encryption algorithm is one where an encryption function E relies on a first key K₁, and a decryption function D relies on a second key K₂, where key K₂ can be derived from key K₁ and key K₁ can be derived from key K₂.

Often K₁=K₂, however even when this is not the case, as each key can be derived from the other, the method of encrypting a message M (or other information stream) to obtain data to be communicated C and vice versa can be defined with reference to a single key K:

E_{K}M=C

D_{K}C=M

An enormous variety of symmetric algorithms of this type exist, the security of which relies on the strength of the algorithms D and E and on the length of K. It has been suggested that 90 bits is an adequate key length, and most algorithms use a key length of around this order of magnitude.

One known algorithm is DES (data Encryption Standard), an international standard, which uses a single key of length 56 bits. It has been shown that the DES algorithm is of limited security and that a brute-force attack with customised computers can obtain the key in as little as 3.5 minutes. Other known encryption algorithms include the Blowfish algorithm, which uses a variable length key of as little as 32 bits, the RC5 algorithm having a 128 bit key, and the IDEA algorithm, also using a 128 bit key.

The preceding description in no way constitutes an admission of the common general knowledge of a person skilled in this field.

### SUMMARY OF THE INVENTION

According to a first aspect the present invention provides a method of data encryption comprising the steps of:

obtaining a plurality of sub-keys from a secure long key, and generating an encryption key from the sub-keys by:

i) assigning a significance to each sub-key from most significant to least significant;

ii) using bit values obtained from a given position of nominated sub-keys to determine a bit of the encryption key;

iii) rotating the bit values of the least significant sub-key;

iv) repeating steps ii) and iii) a predetermined number of times and then rotating a next most significant sub-key; and

v) repeating steps ii), iii) and iv) for one or more of the sub-keys in order of increasing significance.

According to a second aspect the present invention provides a method of data decryption comprising the steps of:

obtaining a plurality of sub-keys from a secure long key; and

generating a decryption key from the sub-keys by:

i) assigning a significance to each sub-key from most significant to least significant;

ii) using bit values obtained from a given position of nominated sub-keys to determine a bit of the decryption key;

iii) rotating the bit values of the least significant sub-key;

iv) repeating steps ii) and iii) a predetermined number of times and then rotating a next most significant sub-key; and

v) repeating steps ii), iii) and iv) for one or more of the sub-keys in order of increasing significance.

According to a third aspect of the invention there is provided a method of data encryption comprising the steps of:

obtaining a plurality of sub-keys from a secure long key;

generating an encryption key from the sub-keys by:

a) differentiating each sub-key from other sub-keys in said plurality of sub-keys;

b) using bit values obtained from a given position of nominated sub-keys to determine a bit of the encryption key;

c) rotating the bit values of one or more nominated sub-keys; and

d) repeating steps b) and c) a predetermined number of times.

According to a fourth aspect of the invention there is provided a method of data decryption comprising the steps of

obtaining a plurality of sub-keys from a secure long key;

generating a decryption key from the sub-keys by:

a) differentiating each sub-key from other sub-keys in said plurality of sub-keys;

b) using bit values obtained from a given position of nominated sub-keys to determine a bit of the decryption key;

c) rotating the bit values of one or more nominated sub-keys; and

d) repeating steps b) and c) a predetermined number of times.

The secure long key is preferably significantly longer than 100 bits, and is currently envisaged as being a random or pseudo-random bit sequence of the order of 1 MB in length.

The given position of each sub-key may be the start or end of each sub-key, or any intermediate position Further, the given position of one sub-key need not be the same as the given position of any other sub-key.

The sub-keys may be selected and operated in any manner from the secure long key, for example by the use of a configuration template. Each sub-key may be of varied length and may be taken from random positions of the secure long key. Moreover, the sub-keys may be taken from partially overlapping portions or even entirely overlapping portions of the secure long key, and may be taken from the secure long key in reverse bit order. Ideally, the selection of the sub-keys will be regularly changed, so that the encryption key or decryption key changes regularly.

Further the length of any sub-key may be changed any number of times during the course of a session (preferably after a complete rotation of that particular sub-key had been completed).

The step of using bit values obtained from a given position of each sub-key to determine a bit of the encryption/decryption key may be performed by XOR-ing each of the bit values, or by any other method which determines a single bit result from the bit values.

The step of rotating the bit values of each sub-key may be performed in a variety of ways, such as shifting all bit values by one position, and moving an end bit value to the start of the sub-key, or by shifting all bit values by 2 or more positions and moving an appropriate number of end bit values to the start of the sub-key. The direction of rotation (or shifting) is not fixed and can be varied for each sub-key, e. g. according to information held in the configuration template. Moreover the variation, such as the direction and extent of rotation, for each sub-key can itself be set by the content of further sub-keys e. g. as defined by the configuration template.

The predetermined number of times may be equal to the number of bits in the sub-key of least significance. Similarly, step v) may be performed until the next most significant sub-key has been rotated a sufficient number of times to return to an original position. In this manner, the sub-keys are treated as ‘tumblers’, with preferably one full rotation of a first sub-key causing rotation of the next most significant sub-key by one or more position(s). Steps iv) and v) of the method of the first aspect of the present invention may be repeated until an encryption key of desired length has been generated, or simply until all sub-keys have been rotated a sufficient number of times to return to an original position at least once. Similarly, steps iv) and v) of the method of the second aspect of the present invention may be repeated until a decryption key of desired length has been generated or simply until all sub-keys have been rotated a sufficient number of times to return to an original position at least once.

According to a fifth aspect of the invention there is provided a system for providing a pseudo random data stream used to encrypt an information stream comprising:

Engine means having a plurality of sub-keys for generating data values to form the pseudo random data stream;

wherein data values derived from the pseudo random data stream operate on the sub-keys of the engine means to change the current data values within the sub-keys.

According to a sixth aspect of the invention there is provided a system for providing a pseudo random data stream used to encrypt an information stream comprising:

engine means having a plurality of sub-keys for generating data values to form the first pseudo random data stream;

wherein data values derived from another pseudo random data stream operate on the sub-keys of the engine means to change the current data values within the sub-keys.

According to a seventh aspect of the invention there is provided a system for providing a pseudo random output stream to encrypt an information stream comprising:

one or more means for providing respective pseudo random data streams;

selector means for receiving the respective pseudo random data streams;

wherein the selector means selects data values from any one or more of the pseudo random data streams to form the pseudo random output data stream.

The rotational mode of the basic engine may be varied in numerous ways for example such as a ‘combination’ mode where all tumblers are rotated together after each iteration, an ‘odometer’ mode where the rotation of one tumbler into its start position engages the rotation of a further tumbler or one of numerous ‘caterpillar’ modes where each iteration sees the rotation of one or more neighbouring tumblers in a sequential manner or finally a ‘random’ mode where each iteration sees the rotation of one or more different tumblers in an apparent random order.

The mode may be configured directly by a value in the configuration template or as previously stated by the selection of particular values to be used in external control tumblers and/or optionally a Control Engine, in effect programming the engine behaviour. Alternatively the values may be derived randomly from a Master Key or other random source so making the behaviour less predictable. Additionally the mode may be changed during the course of an encryption session. Additionally the values derived from one engine can be used as seed values by further engines.

To further improve the unpredictability of the system, feedback may be derived from the pseudo random data stream and applied either directly to the engine (and tumbler contents) or to any part of the configuration template or both. The feedback may be derived directly or indirectly (via additional mechanisms) from the pseudo random data stream and applied either serially or in a parallel fashion. Alternatively a pseudo random stream derived from any other source may be fed into the engine and applied in a similar manner.

In some cases it may be necessary to employ an output buffer to facilitate the derivation of feedback or additional output streams. In these cases it may therefore be necessary to ‘pre-load’ the output buffer either by seeding from a master key or other random source (such as a phrase from a book) or by pre-iterating the engine a number of times sufficient to fill the output buffer. The pre-iteration phase may be continued for a period greater than that required to fill the output buffer as a further variation.

If required a means for deriving from the pseudo random data stream a two dimensional matrix of values by performing additional operations on combinations of nominated values within the pseudo random data stream may be employed. These values may then be used either as feedback or as a further source of random values to be used for encryption and decryption.

Once a matrix (or number of matrices) has been formed, additional values may be generated by combining them. For example, one or more matrices (or parts thereof) may be combined geometrically to form two or more sides of a cube or rectangular box (cuboid) or any other three dimensional shape. Within the shape so formed a lattice would be defined from the intersections of various locations from within the differing matrices. An operator would then be applied to the values from the contributing matrices to arrive at a final value for each intersecting point. Note that a matrix can also be rotated through any plane prior to its use.

The pseudo random output stream may be derived either directly from the engine or indirectly (via additional mechanisms) and may then be further manipulated (values may be randomly changed or deleted) just prior to use. Additionally the pseudo random data stream may then be combined with other pseudo random data streams in numerous ways such as selecting alternate data streams to form a final pseudo random data stream, combining data streams by the use of various operators or by using a data stream to ‘mask’ another data stream, again by the use of various operators.

An encryption key generated by any combination of the above methods may then be used to encrypt an information stream, for example by XOR-ing the encryption key with the information stream to be secured to produce an encrypted information stream (cipher-text). Similarly, the decryption key generated by any combination of the above methods may be used to decrypt an encrypted information stream. Finally ‘camouflage’ values may be added to the encrypted information stream in the form of headers, trailers or random values interleaved with the encrypted information stream according to a nominated method.

Even if an eavesdropper or attacker should obtain information relating to the manner of selection and operation of sub-keys from the secure long key, this information is useless without knowledge of the long key. Similarly, if the encryption key used for a given information stream should be determined, knowledge of that encryption key alone does not enable the attacker to determine the sub-keys, the secure long key or any other encryption key generated by the methods of the present invention.

In some embodiments of the methods of the first and second aspect of the invention, the secure long key may be generated by XOR-ing a plurality of secure base long keys. Embodiments of this type are advantageous in that, even if the security of one of the secure base long keys is compromised, the XOR action with other secure base long keys means that the secure long key itself is not compromised. This is the case provided the security of at least one of the secure base long keys is not compromised.

Evidently, both the source and destination of the encrypted information stream must use the same secure long key and the same manner of selection and operation of sub-keys. The manner of selection and operation of the sub-keys may be made known to both the source and the destination in a number of ways. For instance, information describing the manner of selection and operation of sub-keys may be communicated from the source to the destination along with the encrypted information stream. This information may itself be encrypted (in a manner known to the destination) or may be positioned at a predetermined position within the encrypted information stream. Even if this information is discovered by an attacker, it is useless without knowledge of the secure long key. Alternatively, the manner of selection and operation of sub-keys may be communicated from the source to the destination separately to communication of the encrypted information stream. Alternatively, the manner of selection and operation of sub-keys may change in accordance with a predetermined pattern of which both the destination and source are aware.

The method of the present invention has application in numerous environments, such as the encryption of transmissions over a public network or over an internal network such as a LAN, or a virtual LAN spread over a number of geographical sites such as is used by financial institutions.

The method of the present invention may also be used in real time encryption applications such as mobile telephone communications. For instance, the SIM card of a mobile telephone may be provided with a secure long key, and for each call conducted by the mobile telephone, a new encryption key may be generated in accordance with the method of the first aspect of the invention, and real-time encryption conducted throughout the call. Alternatively, the mobile telephone may be provided with a second SIM card having the secure long key. Further, the SIM card or the second SIM card may have a unique secure long key associated with each of a plurality of telephone numbers which are known to the mobile telephone, such that encrypted communication to one such number may only be decrypted by the party having the same unique secure long key.

The system embodying the invention may be located on, but not limited to, equipment such as routers, firewalls and telephone PABX devices.

The encryption and decryption processes could be in software on computer systems for the secure handling of files and data.

Further the system may be located on a security key device such as a ‘dongle’ which may be used as a physical access key to a computer system, house or motor vehicle.

### BRIEF DESCRIPTION OF THE DRAWINGS

Embodiments of the invention will now be described by way of example with reference to the accompanying drawings in which:

FIG. 1 illustrates selection of sub-keys from a secure long key in accordance with a first embodiment of the present invention;

FIGS. 2a and 2b illustrate generation of an encryption key from the sub-keys;

FIG. 3 illustrates selection of sub-keys from a secure long key in accordance with a second embodiment of the present invention;

FIG. 4 illustrates generation of an encryption key from the tumbling sub-keys;

FIG. 5 illustrates a system used to generate a pseudo random data stream for use in encryption and decryption according to a further embodiment;

FIG. 6 illustrates an engine, part of a configuration template and the application thereto of values from pseudo random sources;

FIG. 7 illustrates the configuration template in further detail;

FIG. 8 illustrates the engine in further detail and various operations occurring within the engine;

FIG. 9 illustrates an output buffer and a pseudo random data stream fed into the output buffer;

FIGS. 10a and 10b illustrate embodiments of direct tumbler feedback arrangements;

FIG. 11a illustrates a matrix generator with values derived from a pseudo random data stream grouped in columns;

FIG. 11b illustrates a single column of values derived from a pseudo random data stream;

FIG. 12 illustrates a three dimensional geometric representation of one or more matrices from which values can be derived;

FIG. 13a illustrates a pseudo random output stream comprising data values selected from pseudo random data streams from a pair of engines; and

FIG. 13b illustrates a pseudo random output stream comprising data values selected from pseudo random data streams from multiple engines.

### DETAILED DESCRIPTION OF EMBODIMENTS OF THE INVENTION

For the purposes of the following discussion, a length of one bit will be used, but the length is not so limited and could in fact be a nibble (4 bits), a byte (8 bits) or any other value Hereinafter and throughout the specification the terms “sub-keys” and “tumblers” are to be used interchangeably. Furthermore, throughout the specification reference to a “message” also includes a reference to a file or any other data stream or data source requiring encryption.

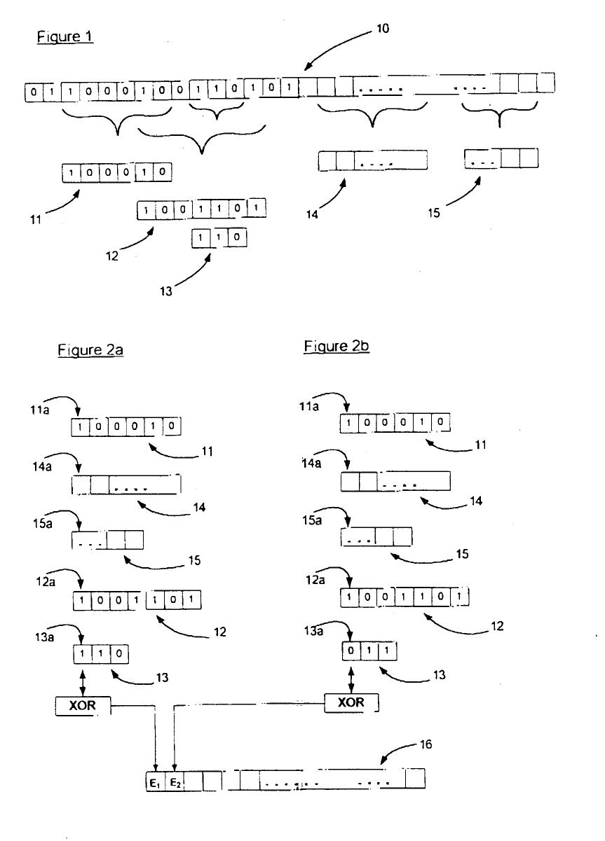

FIG. 1 of the accompanying drawings illustrates a method of encryption in accordance with the present invention. A secure long key 10, which ideally consists of a random or pseudo-random bit sequence, is held by both a source and a destination. Sub-keys 11,12,13,14 and 15 are selected from the secure long key 10. As can be seen, the sub-keys can be of any length greater than, less than or equal to the length of the secure long key 10, and can be chosen such as to partially overlap (11,12) or even completely overlap (12,13).

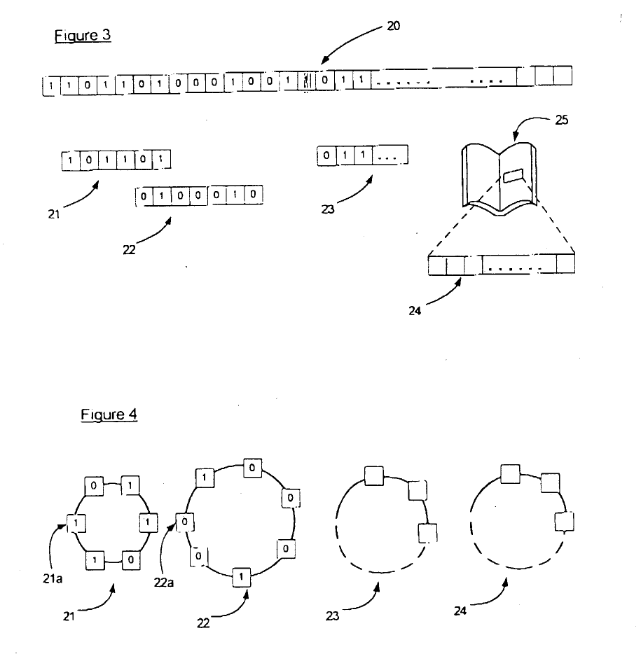

Following the selection of the sub-keys, an encryption key is generated by arranging the sub-keys in order from most significant to least significant. As can be seen in FIG. 2a, the significance of each sub-key can be assigned in any arbitrary manner. In this case sub-key 11 is the most significant, and sub-key 13 the least significant.

To determine the first bit E1 of the encryption key 16, the bit value in the start location of each sub-key (11a, 12a, 13a, 14a, 15a) is XOR-ed. To obtain subsequent bits (E2 etc), each sub-key is then treated as a ‘tumbler’. That is, the least significant sub-key 13 is rotated by one or more bit(s) such that the last bit of that sub-key becomes the first bit of that sub-key and all other bits are shifted by one or more place(s), as shown in FIG. 2b. Again, the bit value in the start location of each sub-key (11a, 12a, 13a, 14a, 15a) is XOR-ed, to produce a value for E2.

It will be appreciated that the location of the bit value which is XOR-ed at each step can be anywhere in each sub-key, however to simplify illustration, the start location is used in the present example.

The next rotation of sub-key 13 (not illustrated) and subsequent XOR function will produce a third bit for the encryption key 16, after which another rotation of the sub-key 13 will return each bit of sub-key 13 to an original position. Hence, at this point, sub-key 12, being the next most significant sub-key, is rotated by a single bit, and then sub-key 13 is again rotated one bit at a time until returning again to the original position, and at each rotation one more bit of the encryption key 16 is generated by the XOR function. Rotation of the sub-keys continues in this manner until an encryption key of desired length has been generated or perhaps until all sub-keys have been rotated at least once to return to their original position, thereby exhausting all outcomes for an XOR operation on the start bit of those sub-keys.

Finally, once the encryption key 16 has been generated by the above method, it is XOR-ed against an information stream and the resulting cipher text either stored or transmitted.

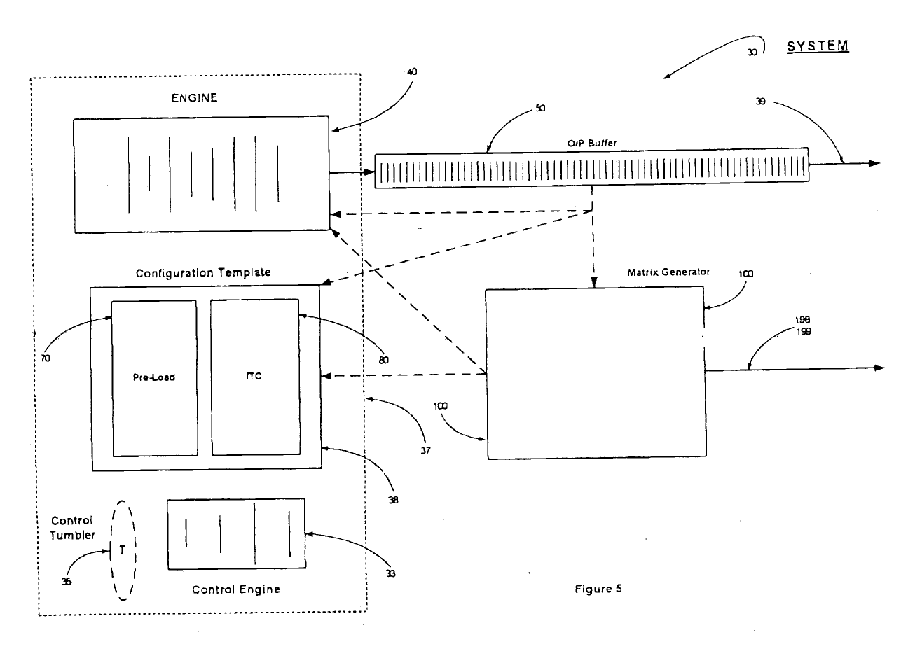

FIG. 3 illustrates a method of encryption in accordance with another embodiment of the present invention. A secure long key 20, consisting of a random or pseudo random bit sequence, is known and held securely by both a source and a destination. Sub-keys 21, 22 and 23 are selected from the secure long key 20. Selection of the sub-keys 21, 22 and 23 from the secure long key 20 is performed in a manner which is known to both the source and destination. Further, an additional sub-key 24 is selected from a section of text from a book 25 in a manner which is known to both the source and destination. Sub-key 24 is digitised from the text of book 25. Alternatively, the sub-key 24 can be derived from another pseudo random source instead of the indicated book 25.

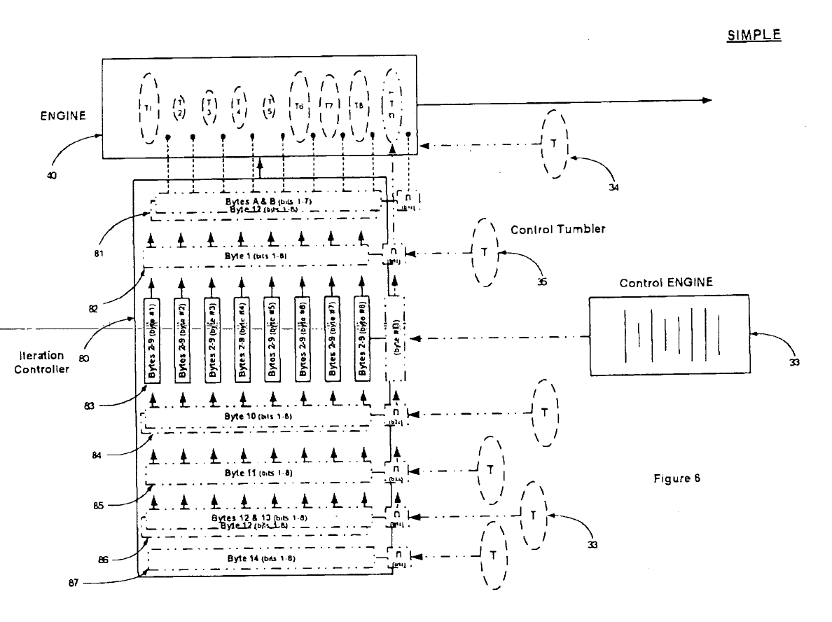

Following the selection of the sub-keys, an encryption key is generated by arranging the sub-keys in order from most significant to least significant. As can be seen in FIG. 4, the significance of each sub-key in this embodiment is in the order of, from most significant to least significant, 21,22,23 and finally 24.

To determine a bit of the encryption key, the bit value in a start location of each sub-key (21a, 22a, etc) is XOR-ed or otherwise used to determine a single bit of the encryption key. To obtain subsequent bits of the encryption key, each of the sub-keys (21,22,23,24) is then treated as a tumbler as illustrated in FIG. 4 The least significant sub-key (24) is rotated by a single bit after which the bit value in the new start location of each sub-key (21a, 22a, etc) is again XOR-ed or otherwise used to obtain a bit of the encryption key. Subsequently, tumbler 24 continues rotation until it has returned to an original position, after which the sub-key (or tumbler) of next most significance (23) is rotated by a single bit. Rotation of the sub-keys continues in this manner until an encryption key of desired length has been generated, or alternatively, until all sub-keys have been rotated at least once to return to their original position, thereby exhausting all outcomes for an XOR or other operation on the start bit of each sub-key.

Following generation of the key in this manner, it may then be used to encrypt (or decrypt) an information stream.

Alternatively following the selection of the sub-keys, an encryption key is generated by arranging the sub-keys in order from most significant to least significant. As can be seen in FIG. 4, the significance of each sub-key in this embodiment is in the order of, from most significant to least significant, 21,22,23 and finally 24.

To determine a bit of the encryption key, the bit value in a start location of each sub-key (21a, 22a, etc) is XOR-ed or otherwise used to determine a single bit of the encryption key. To obtain subsequent bits of the encryption key, each of the sub-keys (21, 22, 23, 24) is then treated as a tumbler as illustrated in FIG. 4. All of the sub-keys (21, 22, 23, 24) are rotated by a single bit after which the bit value in the new start location of each sub-key (21a, 22a, etc) is again XOR-ed or otherwise used to obtain a bit of the encryption key. Rotation of the sub-keys continues in this manner until an encryption key of desired length has been generated, or alternatively, until all sub-keys have been rotated at least once to return to their original position, thereby exhausting all outcomes for an XOR or other operation on the start bit of each sub-key.

Following generation of the key in this manner, it can then be used to encrypt (or decrypt) an information stream.

Alternatively following the selection of the sub-keys, an encryption key is generated by arranging the sub-keys in order from most significant to least significant. As can be seen in FIG. 4, the significance of each sub-key in this embodiment is in the order of, from most significant to least significant, 21,22,23 and finally 24.

To determine a bit of the encryption key, the bit value in a start location of each sub-key (21a, 22a, etc) is XOR-ed or otherwise used to determine a single bit of the encryption key. To obtain subsequent bits of the encryption key, each of the sub-keys (21, 22, 23, 24) is then treated as a tumbler as illustrated in FIG. 4. Each of the sub-keys (21, 22, 23, 24) is rotated by a single bit in a sequential order (changing the start location of that sub-key), and in between each rotation the bit value in the current start location of each sub-key (21a, 22a, etc) is again XOR-ed or otherwise used to obtain a bit of the encryption key. Rotation of the sub-keys continues in this manner until an encryption key of desired length has been generated, or alternatively, until all sub-keys have been rotated at least once to return to their original position, thereby exhausting all outcomes for an XOR or other operation on the start bit of each sub-key.

Following generation of the key in this manner, it can then be used to encrypt (or decrypt) an information stream.

Alternatively following the selection of the sub-keys, an encryption key is generated by arranging the sub-keys in order from most significant to least significant. As can be seen in FIG. 4, the significance of each sub-key in this embodiment is in the order of, from most significant to least significant, 21,22,23 and finally 24.

To determine a bit of the encryption key, the bit value in a start location of each sub-key (21a, 22a, etc) is XOR-ed or otherwise used to determine a single bit of the encryption key. To obtain subsequent bits of the encryption key, each of the sub-keys (21, 22, 23, 24) is then treated as a tumbler as illustrated in FIG. 4. Each of the sub-keys (21, 22, 23, 24) is rotated by a single bit in a random order, and in between each rotation the bit value in the new start location of each sub-key (21a, 22a, etc) is again XOR-ed or otherwise used to obtain a bit of the encryption key. Rotation of the sub-keys continues in this manner until an encryption key of desired length has been generated, or alternatively, until all sub-keys have been rotated at least once to return to their original position, thereby exhausting all outcomes for an XOR or other operation on the start bit of each sub-key

Following generation of the key in this manner, it can then be used to encrypt (or decrypt) an information stream.

Again with reference to the following Figures, all values that are shown are arbitrary. For example, where a byte value is shown, it could be implemented also as a bit, a nibble, a word or any other value. The number of tumblers and of any bytes or bits in any given tumbler is also arbitrary and can vary from session to session if required. Where a “Take Off” interval is shown to be every third byte, for example, it could alternatively be 0 or 2 or any other value or interval of bytes.

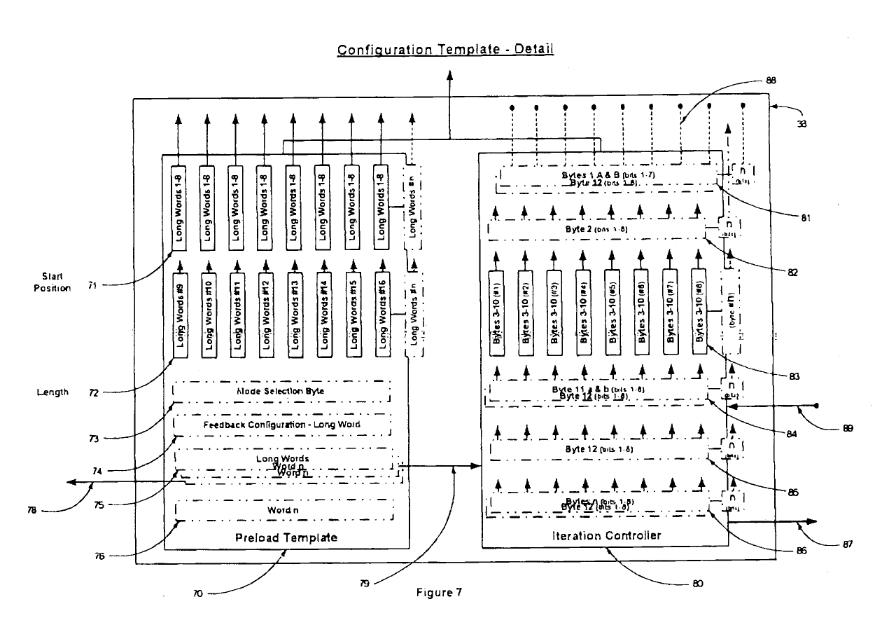

According to further embodiments as shown in outline form in FIG. 5, there is disclosed a system used to generate a pseudo random data stream to be used for encryption and decryption. This can be performed by the application of further variations to the components so far described, and/or by combining the components so far described with additional components in various new configurations.

In FIG. 5 the system 30 shows an engine 40, a configuration template 38, an output buffer 50, and a matrix generator 100. The engine 40, configuration template 38, tumblers 35 and other engines 33 are collectively grouped in the box 37 to indicate existing components which will be described in more detail below. Also shown (by the use of dotted lines) are the potential data paths that can be used. The output can be derived directly from the engine 40, or the output buffer 50, or indirectly via the matrix generator 100, in either serial or parallel. Equally feedback can be derived directly from the output buffer 50, or indirectly via the matrix generator 100, in either serial or parallel. Feedback can then be applied either directly to the engine 40 (and tumbler contents) or the configuration template 38 (and register contents) or both.

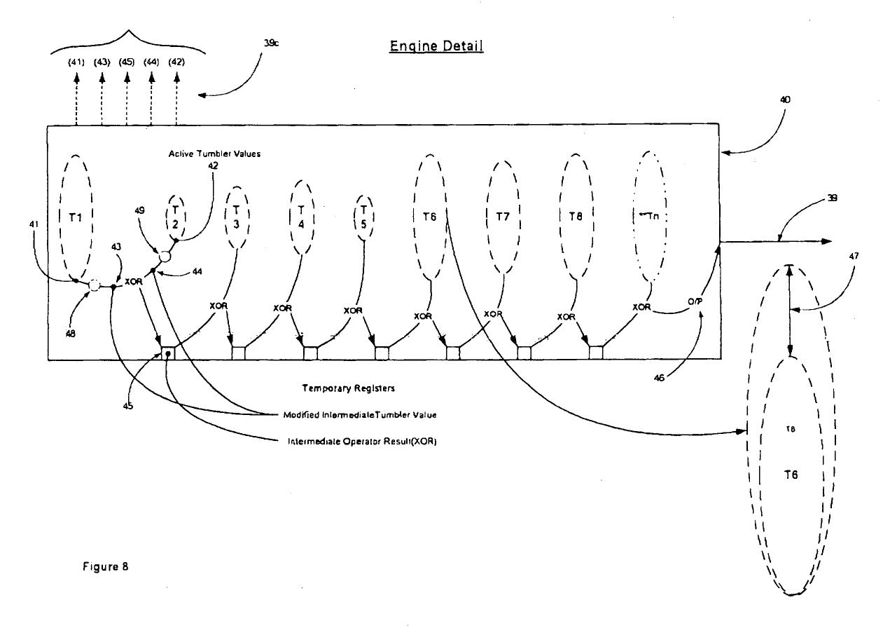

Shown in FIG. 6 is the engine 40 consisting of a number of Tumblers represented as T1 through to T8 and optionally up to Tn for n separate tumblers. Also shown is the application of values from external tumblers 35 or another engine 33 to the configuration template to in effect ‘programme’ the operation of the main engine 40. This would be for example one way of altering the rotational behaviour of the sub-keys (or tumblers). Alternatively these values can be derived from any other pseudo random source so as to further reduce the predictability of the engine 40 and therefore the pseudo random data stream 39. Additionally the values so derived can be applied directly to components of the engine 40 and the values contained therein such as the tumblers as in 34.

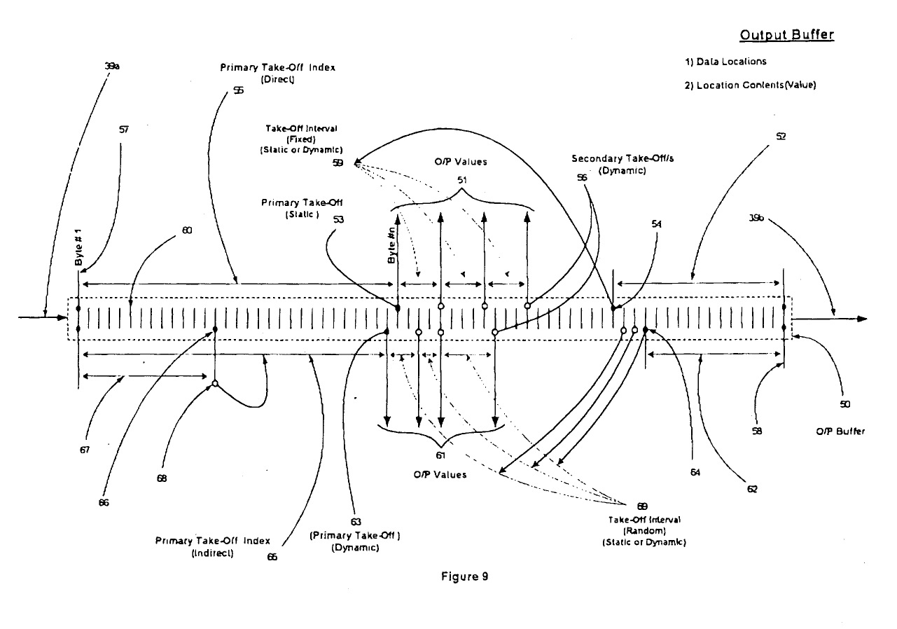

Shown in more detail in FIG. 7 is the configuration template 38 which is in this example divided into two areas, a pre-iteration loader identified as the pre-load template 70 and the iteration controller 80. The configuration template 38 is essentially a register set comprising for example a number of bytes 82, 85, byte pairs 81, 84, words 76 or long words 71, 73 or any other value group.

The register contents can be used for example to control the operation of the tumblers 88 or the manner of manipulation and use of values or functions within any of the system components. This would include the application of configuration or control values to subsets of the configuration template itself (such as the iteration controller 80) as is shown for example by the control path 79. Alternatively the register contents can be used to configure or control any external devices that have been added to the system via the control paths 78, 87.

All registers are optional and additional registers can be added if required to further extend operational possibilities within the engine or feedback mechanisms or not used to simplify a particular implementation. Note for example the differences between the embodiment of the iteration controller shown in FIG. 6 and that shown in FIG. 7 ie the numbering schema and the additional register. When in use, a bit or bits (or bit pairs from byte pairs) or in some cases whole bytes or larger values, each corresponding to an intermediate or sub-component, could define an operation or other effect required.

The pre-load template 70 is used to pre-configure the engine 40, the iteration controller 80, the output buffer 50, the matrix generator 100 and any additional components that have been added to the system prior to the operation of the engine, this would include for example an option to allow external devices that have been added later to be configured by registers within the pre-load template 70. In this example the long words 71 are used to indicate the start position of the tumblers as they are extracted from the Master Key/s, the long words 72 are used to indicate their length, byte 73 is to indicate the operational mode of the tumblers, byte 74 is used to indicate the feedback configuration while the long words 75 can be reserved for external use and the word/s 76 can be used for selection of intermediate operations in the engine or to select the meaning of bit values in the iteration controller 80 eg. In addition, further bytes can be added to the register set to define additional parameters such as for example an extraction interval between values derived from the Master Key/s and the extraction order.

In this example of the iteration controller 80, bytes 1A and 1B (81) define an active logical operator for each of the tumblers in the engine. They define the operation that will be used between the current value presented by a given tumbler and the next active tumbler. A default is normally XOR. When in use, a bit from each byte can define the output code as follows; 00 for Mask NOT (Complement), 01 for Mask OR, 10 for XOR and 11 for Mask AND. Byte 82 is used to indicate whether a tumbler has an output that is active while byte 85 can be used to indicate whether the rotation of a tumbler will be active at the end of the current iteration. The various bytes 83 can be used to indicate the extent of rotation at the end of the iteration, in this case one byte per tumbler while byte/s 84 can be used ‘to indicate direction of rotation of the tumblers. Byte/s 86 are used to indicate intermediate byte inversion or masking. If one byte is used then only one of two operations can be performed on the current tumbler value as indicated by the use of the various bits within the byte (one bit per tumbler) as being on or off, the operation to be used can be pre-selected in the pre-load template section 70 of the configuration template 38. When two bytes are used a bit from each byte can define the output code as follows; 11 for AND, 01 for OR, 10 for NOT or 00 for NO-OP. Alternatively three bytes can be used to further increase the number and type of intermediate operations. Note that where masking operations are selected a masking byte/s must also be supplied and can be:the same byte for all tumblers or different bytes for each tumbler. Therefore the byte/s 84 essentially perform a pre-filter operation to the tumbler outputs before they are used as further described below. Each of the byte/s 81, 82, 84 etc can be directly controlled by another tumbler 35 or any other input stream as can the byte group 83 shown here being controlled by another control engine 33.

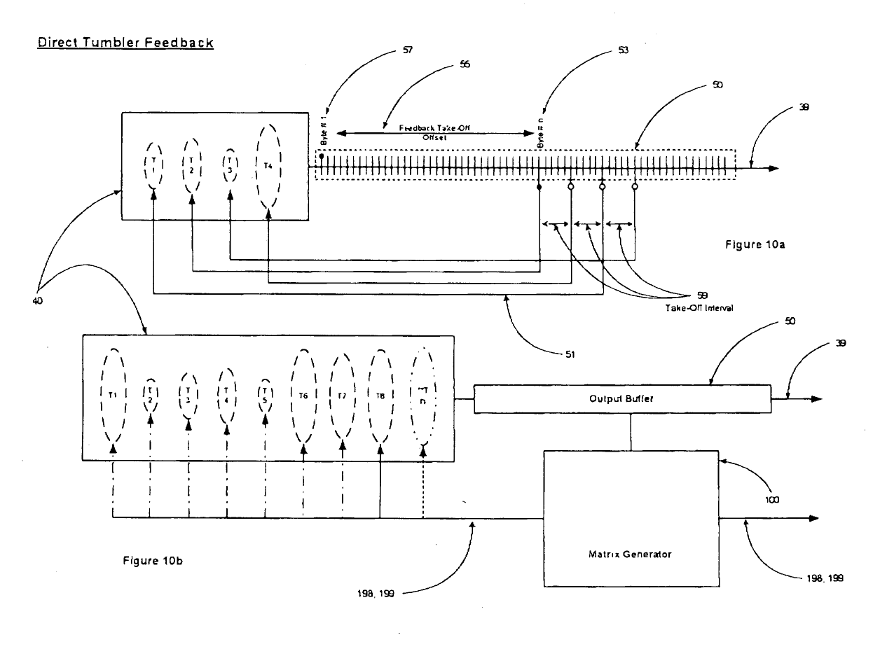

In FIG. 8 the engine 40 is shown in more detail. In simple operation the current active values of the tumblers 41, 42 are combined (in this case using an XOR operation as indicated by bytes 81 of the iteration controller 80) and the result placed in a temporary register 45. This temporary result is then combined (again using an XOR operation) with the contents of the next tumbler T3 and the result again placed in a corresponding temporary register. Note that if a tumbler is not active the temporary result is then simply combined with the next active tumbler. These operations continue for each tumbler that is active until a final output value 46 is arrived at. After the final result has been determined each tumbler is rotated to the extent and in a direction determined by the configuration template. Note however that if feedback has been defined to change the contents of tumblers after use it must precede the rotation phase. Additionally the length of any tumbler such as T6 (47) can be changed any number of times during the course of a session (preferably after a complete rotation of that particular sub-key had been completed).

When intermediate operations 48, 49 are enabled the effect of the byte pair 86 (intermediate operator) from FIG. 7 can be seen at work in FIG. 8 on tumblers T1 and T2. In this example bit pairs (one bit from each byte) from the register pair 86 corresponding to the tumblers T1 and T2 would identify a masking operation 48, 49 to be performed on the current active values 41, 42 of T1 and T2 (Note again that a mask value/s would need to be supplied). These operations 48, 49 would be initiated causing intermediate results to become available at 43 and 44. Thereafter the principle operation between T1 and T2 (in this case an XOR—selected by register pair 81 of FIG. 7) can be initiated and further intermediate results therefrom stored at 45. This process is repeated for each active tumbler as indicated by register 82. After all intermediate operations have been completed in sequence and the final output byte 46 is generated, one or more nominated tumblers are rotated under control of register 85 (FIG. 7), to an extent and direction determined by the contents of the registers 83 & 84 (FIG. 7) indicated in the iteration controller 80. Note again that if feedback has been defined to change the contents of tumblers after use it must precede the rotation phase.

All intermediate values (and any new tumbler values created by feedback) can be derived from the engine in a parallel format as additional pseudo random data streams (39c). This is of particular importance in feedback configurations whereby the contents of the tumblers are changed prior to rotation. Additionally the values derived from one engine can be used as seed values by further engines.

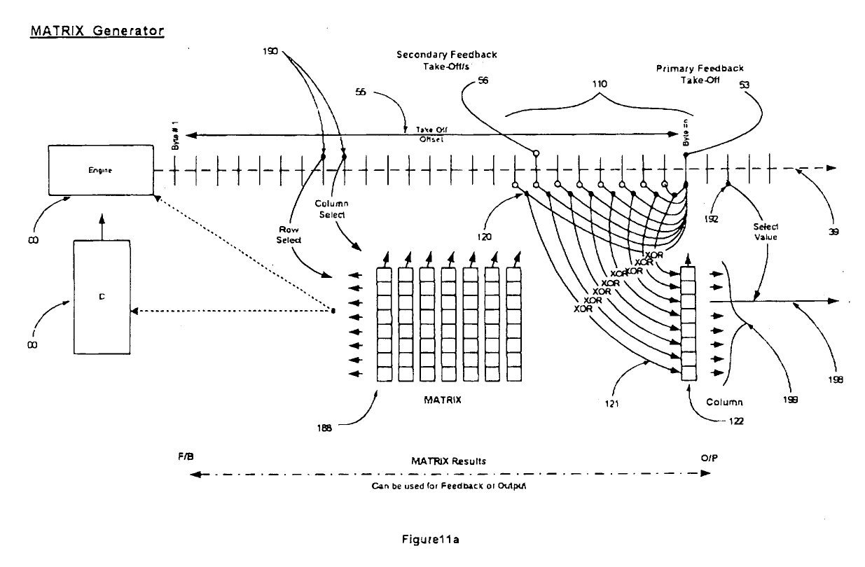

With reference now to FIG. 9, there is shown an output buffer 50 having a pseudo random data stream which; is fed into the output buffer at 39a and leaves the output buffer at 39b. The reader will note that in this Figure there are many shared and related concepts that have been grouped for convenience but differentiated by slight differences in the numbering ranges used. In this example of the embodiment each vertical line 60 within the indicated buffer is used herein to represent a single byte value. The output buffer is a temporary store for the pseudo random data stream emanating from the engine means 40 and operates on a first in first out (FIFO) basis but with the additional property of being random access. The output buffer is used to facilitate the derivation of values 51 or 61 from various locations (take-off points) within the pseudo random data stream to be used either as feedback or to generate additional pseudo random data streams. Feedback values can be derived from nominal 53 or variable 63 locations within the output buffer 50 and applied to either the configuration template 38 or directly sack to the engine 40. The techniques for identifying locations within the output buffer 50 (identified in the Figures as ‘Take-Off’ points for example 53, 63) would be similar to those used within standard CPU designs for memory addressing. Locations within the output buffer 50 would be expected to be defined either directly 55 or indirectly 65. Direct locations would be defined for example by using the value contents of registers 75 within the configuration template 38 to identify the final location 53 in the form of an offset from a stated position 57. Indirect locations (otherwise referred to as variable or dynamic offsets) would be defined for example, by using the value contents of registers 75 within the configuration template 38 to identify an intermediate location 66 in the form of an offset 67 from a stated position 57, and the value derived therefrom 68 being used to identify the final location 63, again in the form of an offset 65 from a stated position 57. Where a number of bytes are to be derived from the output buffer simultaneously an interval 59, 69 (the Take-Off intervals, can be specified between neighbouring take-off points, with a first location being defined as the primary take-off point as in 53 or 63 and additional locations being defined as secondary take-off points 56. The take-off interval can be static and its value defined directly by the contents of a register value in the configuration template 38. Alternatively the take-off interval can be dynamic (ie variable) and its value derived from a location 54, 64 in the output buffer, and in this case it is the offset 52, 62 which is defined by the contents of the register value in the configuration template 38. Additionally the take-off interval can be of a fixed value between each neighbouring take-off point as in 59 (the interval applied being determined by the contents of a single bye value at 54) or the take-off interval between each neighbouring take-off point can be random as in 69 (indicated by multiple values starting at 64). Note also that offsets 52 and 62 are applied relative to the end 58 of the output buffer 50.

The output buffer 50 can also be seeded either from any random source (such as a passage from a book) or by a counter sub-system or by iterating the engine means 40 a predetermined number of times. This can be 512 times for example where the output buffer is 512 bytes in length.

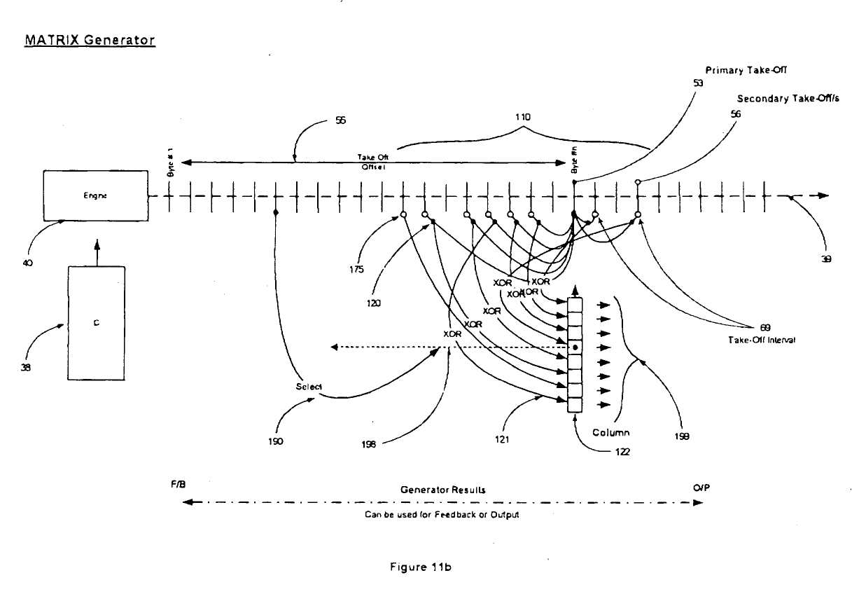

Referring now to FIGS. 10a and 10b, there is shown a direct tumbler feedback arrangement having engine 40 and output buffer 50. For each iteration nominated values 51 or 61 derived from the output buffer 50 (or alternatively values 198, 199 from the matrix generator 100) can be applied (using any operation including substitution) to the contents of the currently active values in any of the tumblers T1 through Tn—after they have been used (to generate an intermediate or output value)—but—just before rotation of the tumblers. In this way the values of the tumblers would change after use in a less predictable fashion. The difference in this particular embodiment is that the output from the buffer 50 (or alternatively the matrix generator 100) is used to change the values in nominated tumblers. Note that care needs to be exercised in the choice of feedback method (ie the number of taps applied and the source of the taps) relative to the tumbler sizes and mode that is in effect at that particular time. It is also to be noted in this example that a configuration template or iteration controller is not specified, however they can be implemented as required. Additionally a pseudo random stream derived from any other source may be fed into the engine and applied in a similar manner as in 34 (FIG. 6).

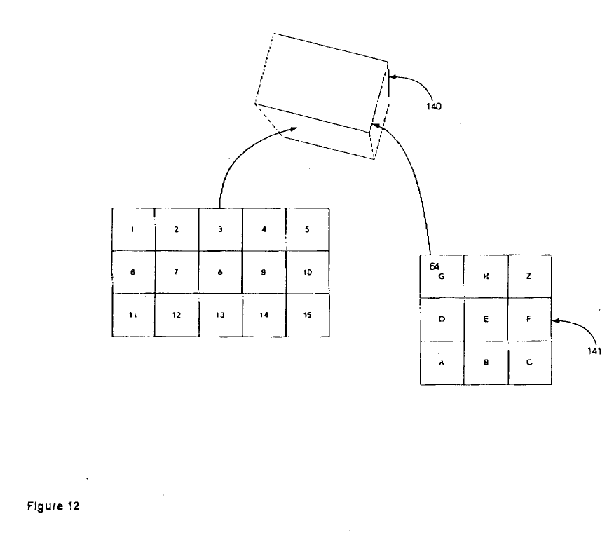

With reference to FIGS. 11a and 11b there is shown a matrix generator 100 which can be used to provide either serial 198, or parallel 199 feedback or further indirect outputs, again in serial 198, or parallel 199. From nominal points eg 53, 56 within the pseudo random data stream 39 a series of values 110 are extracted from a primary take off point at 53 and a number of secondary take off points eg 56. An operator is applied 120 (in this case an XOR) between each of the values at the secondary take off points and the value of the primary take off point 53. The resulting values 121 are then stacked into a column 122. A number of columns (each having primary and secondary take off points) can in turn be stacked side by side to form an array or matrix 188. Selection of values from the matrix can be made by use of values derived from the pseudo random data stream, for example at positions 190 and 192. There is no restriction on the position of primary and secondary take off points within the pseudo random data stream during generation of the matrix 188, and these can either be statically defined or dynamically defined (by the use of indirect values derived from the pseudo random data stream). Each column though will have a primary take off point 53 and a number of secondary take off points 56. The number of columns and secondary take off points is not limited. At a first appraisal it might be considered that the number and depth of columns should riot extend beyond the total finite length of the pseudo random data streams. However, it is possible that a primary take off can be used more than once with differing sets of secondary take off points allowing the formation of more columns than there are values in the pseudo random data stream. Equally, secondary take off points within a column can be used more than once in a random manner to form columns deeper than the length of the pseudo random data stream. Note that values can also be derived by applying an operation (such as an XOR) between values derived from neighbouring secondary take off points to arrive at a result rather than from secondary to primary only Multiple matrices can be formed from a single pseudo random data stream.

It will be appreciated by those skilled in the art that numerous possible embodiments comprising variations or sub sets of a simpler nature can be derived from the matrix. For example in FIG. 11b a single register set holding only the values derived for a single column 122 can employed. This register set would be refreshed with each iteration and its contents made available either for output or feedback 199. Similarly just a single value (serial) can be derived from the column in a pseudo random manner by the use of an index byte 192 derived from the pseudo random data stream 39 and made available either for output or feedback 198.

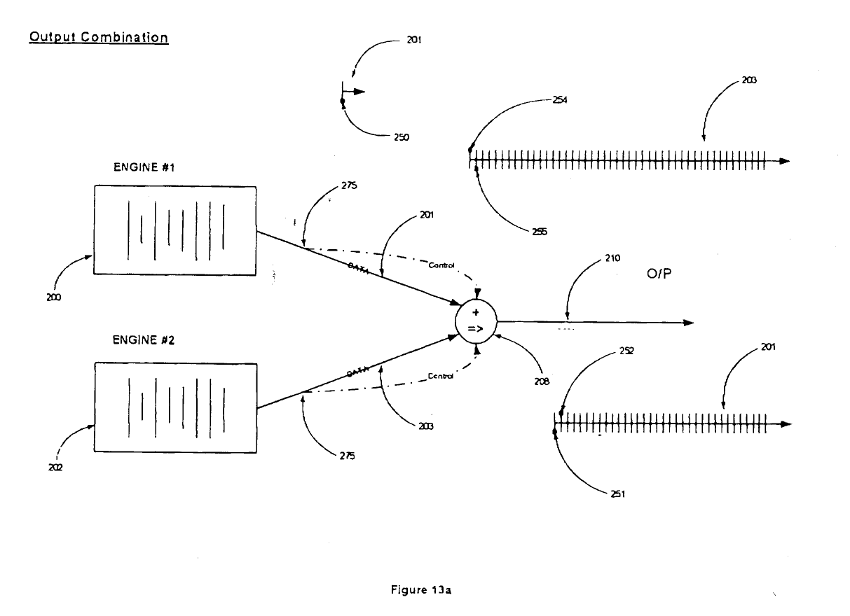

Once matrices are formed, additional, values can be generated by combining them as in FIG. 12. For example, one or more matrices 188 (or parts thereof) can be combined geometrically to form the sides of a box or rectangle or any other shape. Within the shape so formed a lattice 140 would be defined from the intersections of various locations from within the differing matrices. An operator would then be applied to the values from the contributing matrices to arrive at a final value for each intersecting point. The matrix can also be rotated through any plane prior to its use as in for example where the matrix shown 141 has been rotated through 180 degrees in a vertical plane.

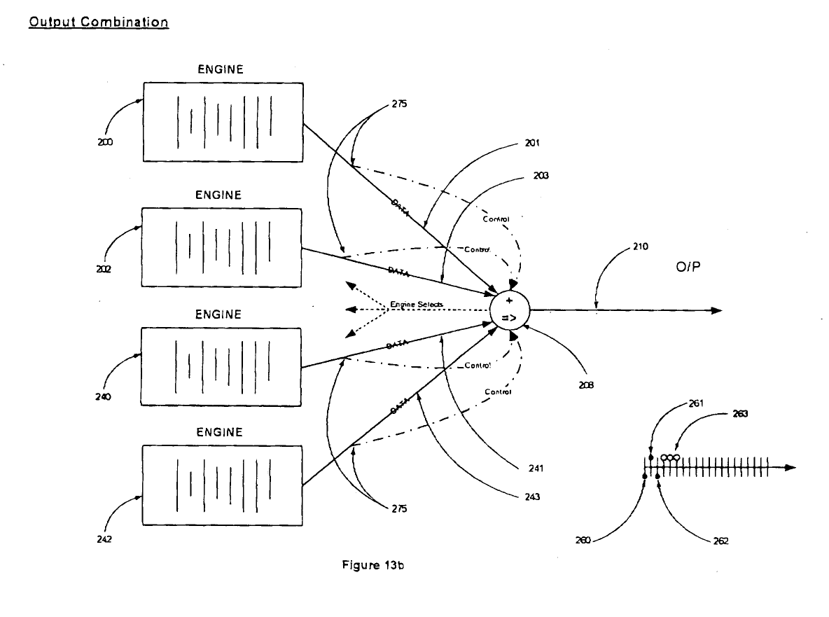

In FIGS. 13a and 13b there are shown means for combining the output streams of two or more engines. Note that only the engines are shown for clarity, alternatively the engines can be employed with all (of the aforementioned components ie engine 40, output buffer 50, configuration template 38, matrix generator 100, and any additional components that can be controlled by the configuration template. In FIG. 13a there are shown two engines 200 and 202 which have data streams 201 and 203 respectively fed to a hub 208 which can select either data stream 201 or 203 for the output stream 210, or alternatively operate on one of the data streams under control of the other. The selection or operation would last for a period of time equivalent to a number of iterations as defined by nominal bytes (250, 251, 252, 254, 255) within the data streams themselves. Note also that the pseudo random output stream 210 follows the hub 208, while pseudo random data streams 201, 203 (and 241, 243) feed into the hub 208.

Shown in FIG. 13a is a means whereby the pseudo random data streams 201, 203 of each engine 200 and 202 are used to in effect to control the content of the final pseudo random output stream 210. For example in a simple substitution embodiment; to start the process engine 200 wiII output one byte only 250, which is then examined and might for example be 57 indicating that 57 bytes 201 will be derived from engine 202 to go into the pseudo random output stream 210. After the 57th iteration of engine 202 the value of the 57th byte (the last byte) 251 from engine 202 is then examined and might for example be 63, indicating that 63 bytes will now be derived from engine 200 to go into the pseudo random output stream 210 and the process is repeated. After the 63rd iteration of engine 200 the value of the 63rd byte (the last byte) 254 from engine 200 is then examined and might for example be 14, now indicating that 14 bytes are to be derived from engine 202 to go into the output stream 210 and the process is again repeated. Thus control passes in effect from one pseudo random data stream (201, 203) to the other. Additionally the second last byte 252, 255 can also be brought into play to select the operation to be performed on the pseudo random data streams of both engines for the number iterations indicated by the last byte of the pseudo random data stream that has control. Note that control rests with the pseudo random data stream that is active.

With reference to FIG. 13b, there is shown a slightly different arrangement whereby multiple engines in this case four 200, 202, 240, 242 (optionally with associated output buffers and matrix generators) can be used together allowing the creation of more complex output streams.

As with FIG. 13a bytes from a pseudo random data stream (201, 203, 241, 243) can be combined within the hub 208 by the use of selected operations with those of another stream/s including substitution and interleaving, or bytes can be simply discarded. Alternatively the hub can use all of the methods described in combination or alternate between them. In each case the control bytes 275, would be derived from the pseudo random data stream that is currently master and would indicate for example the number of bytes to be derived 260, from which engine/s 261 (top nibble), the operation/s to be performed 262 and which stream is the next master 261 (bottom nibble). Note that additional byte/s 263 can be derived from the pseudo random data streams to further increase the complexity of operations used to combine the data streams.

For example 431 bytes can be selected from engine 200 and passed directly to the pseudo random output stream, then 234 bytes can be selected and inverted from engine 244 and passed to the pseudo random output stream, then 1254 bytes from engine 202 can be combined (XOR) with half that number from engine 200 in an interleave mode and passed to the pseudo random output stream, then 123 bytes from engine 240 can be masked (NAND) with a similar number of bytes from engine 242 according to a template derived from engine 200 and passed to the pseudo random output stream, then 1600 bytes from engine 240 are passed to the pseudo random output stream minus bytes that have been deleted according to an interval defined by control nibbles supplied by the pseudo random output stream of engine 200, continuing in this manner until sufficient bytes have been generated.

Note also that the logic circuitry combine an information stream with the pseudo random output stream can be included in the hub 208 and further bytes from the current control stream used to define the operation (XOR/modulo addition) that combines them. For example one of the bytes 263 can be used such that the upper nibble would indicate the number of bytes from the pseudo random output stream to be XOR'ed with the information stream, while the lower nibble would indicate how many bytes from the pseudo random output stream would be added modulo-256 to the information stream. This would continue until the expiration of the current control stream at which point it would break off and derive a new byte (nibble pair) from the next control stream.

It will be appreciated by persons skilled in the art that numerous variations and/or modifications can be made to the invention as shown in the specific embodiments without departing from the scope of the invention as broadly described. The present embodiments are, therefore, to be considered in all respects as illustrative and not restrictive.

1. A method of data encryption comprising the steps of:
obtaining a plurality of sub-keys from a secure long key; and
generating an encryption key from the sub-keys by:
i) assigning a significance to each sub-key from most significant to least significant;
ii) using bit values obtained from a given position of each sub-key to determine a bit of the encryption key;
iii) rotating the bit values of the least significant sub-key;
iv) repeating steps ii) and iii) a predetermined number of times and then rotating a next most significant sub-key; and
v) repeating steps ii), iii) and iv) for one or more of the sub-keys in order of increasing significance.

2. A method of data decryption comprising the steps of:
obtaining a plurality of sub-keys from a secure long key; and
generating a decryption key from the sub-keys by:
i) assigning a significance to each sub-key from most significant to least significant;
ii) using bit values obtained from a given position of each sub-key to determine a bit of the decryption key;
iii) rotating the bit values of the least significant sub-key;
iv) repeating steps ii) and iii) a predetermined number of times and then rotating a next most significant sub-key; and
v) repeating steps ii), iii) and iv) for one or more of the sub-keys in order of increasing significance.

3. A method of data encryption comprising the steps of:
obtaining a plurality of sub-keys from a secure long key;
generating an encryption key from the sub-keys by;
a) differentiating each sub-key from other sub-keys in said plurality of sub-keys;
b) using bit values obtained from a given position of nominated sub-keys to determine a bit of the encryption key;
c) rotating the bit values of one or more nominated sub-keys, and
d) repeating steps b) and c) a predetermined number of times.

4. A method of data decryption comprising the steps of:
obtaining a plurality of sub-keys from a secure long key;
generating a decryption key from the sub-keys by;
a) differentiating each sub-key from other sub-keys in said plurality of sub-keys;
b) using bit values obtained from a given position of nominated sub-keys to determine a bit of the decryption key;
c) rotating the bit values of one or more nominated sub-keys; and
d) repeating steps b) and c) a predetermined number of times.

5. A method according to claim 3, in which the secure long key is a random or pseudo-random bit sequence of the order of 1 MB in length.

6. A method according to claim 3, in which the given position of each sub-key is the start or end of each sub-key.

7. A method according to claim 3, comprising using a configuration template to select and operate the sub-keys.

8. A method according to claim 7 wherein the configuration template has one or more registers that control the operation of the sub-keys.

9. A method according to claim 7, comprising using the configuration template to determine the direction of rotation for each sub-key.

10. A method according to claim 7, comprising using the configuration template to determine the extent of rotation for each sub-key.

11. A method according to claim 9, further comprising using the content of one or more sub-key(s) to determine the direction of rotation.

12. A method according to claim 10, comprising using the content of one or more sub-key(s) to determine the extent of rotation.

13. A method according to claim 9, further comprising using one or more data streams defined by the configuration template to determine the direction of rotation.

14. A method according to claim 10, comprising using one or more data streams defined by the configuration template to determine the extent of rotation.

15. A method according to claim 3, further comprising performing steps (iv) and (v) until an encryption key of desired length has been generated, or until all sub-keys have been rotated a sufficient number of times to return to an original position at least once.

16. A computer program for carrying out the method according to claim 3.

17. Data processing apparatus arranged to carry out the method of claim 3.

18. A method according to claim 3, wherein each sub-key is variable in length.

19. A method according to claim 3, wherein each sub-key is taken from random positions of the secure long key.

20. A method according to claim 3, wherein the sub-keys are taken from partially overlapping portions or entirely overlapping portions of the secure long key.

21. A method according to claim 3, wherein the sub-keys are taken from the secure long key in reverse order.

22. A method according to claim 3, wherein the sub-keys are derived from any other random source, such as a passage from a book.

23. A method according to claim 3, wherein the step of using bit values obtained from a given position of each sub-key to determine a bit of the encryption key is performed by an operation on each of the bit values.

24. A method according the claim 7 wherein the step of using bit values obtained from a given position of each sub-key to determine a bit of the encryption key is performed by an operation on each of the bit values, the operation being selected by the configuration template.

25. A method according to claim 3, wherein the secure long key may be generated by performing an operation on a plurality of secure base long keys.

26. A method according to claim 3, wherein the bit values are grouped as any one of a nibble, a byte or any other value.

27. A system for providing a pseudo random data stream used to encrypt an information stream comprising:
Engine means having a plurality of sub-keys for generating data values to form the pseudo random data stream;
wherein data values derived from the pseudo random data stream operate on the sub-keys of the engine means to change the current data values within the sub-keys.

28. A system according to claim 27 wherein the data values are forwarded to a configuration template, the template on receiving the data values controlling use of the sub-keys in the engine means.

29. A system according to claim 27 further comprising a matrix generator for generating one or more columns of altered data values from the data values of the pseudo random data stream, wherein the columns combined side by side form the matrix.

30. A system according to claim 29 wherein any one or more of the altered data values in the matrix are fed back directly for use in the engine means.

31. A system according to claim 29 wherein any of one or more of the altered data values derived from the matrix generator are forwarded to a configuration template, the template on receiving the altered data values controlling the behaviour of the sub-keys in the engine means.

32. A system for providing a random data stream used to encrypt an information stream comprising:
engine means having a plurality of sub-keys for generating data values to form the first pseudo random data stream;
wherein data values derived from another pseudo random data stream operate on the sub-keys of the engine means to change the current data values within the sub-keys.

33. A system for providing a pseudo random output stream to encrypt an information stream comprising:
one or more means for providing respective pseudo random data streams;
selector means for receiving the respective pseudo random data streams;
wherein the selector means selects data values from any one or more of the pseudo random data streams to form the pseudo random output data stream.

34. A system according to claim 33 wherein the selector means selects subsequent mean/s for providing pseudo random data streams, and the number of data values from the pseudo random data stream/s of We subsequent means, on the basis of the data values within the current pseudo random data stream received at the selector means.

35. A system according to claim 33 having a first means and a second means for providing respective pseudo random data streams wherein the selector means selects the number of data values alternately from the respective pseudo random data streams from the first means and second means to form the combined pseudo random output data stream.

36. A system according to claim 35 wherein the selection is based on a data value of the current pseudo random data stream received at the selector means.

37. A system according to claim 33 wherein the means for providing a pseudo random data stream is an engine comprising one or more sub-keys.

38. A system according to claim 33 wherein the means for providing a pseudo random data stream is a matrix generator.
